(19) United States
(12) Patent Application Publication
(10) Pub. No.: US 2006/0048189 A1
(43) Pub. Date: Mar. 2, 2006

(54) Method and apparatus for proactive recording and displaying of preferred television program by user's eye gaze

(75) Inventors: Tae-suh Park, Yongin-si (KR); Hee-seob Ryu, Seongnam-si (KR); Ho-joon Yoo, Goyang-si (KR); Sang-goog Lee, Anyang-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/194,484

(22) Filed: Aug. 2, 2005

(30) Foreign Application Priority Data
Aug. 28, 2004 (KR) 10-2004-0068289

(51) Int. Cl. H04N 5/445; H04H 9/00; H04N 7/16

(52) U.S. Cl. 725/46; 725/9; 725/12

(57) ABSTRACT

A method and apparatus for proactive recording and displaying of a preferred television (TV) program, determined based on a user's eye gaze, are provided. The method includes extracting a parameter used to estimate a preference of the user for a currently broadcast TV program from information on the user's eye gaze obtained through a camera; estimating the preference based on the extracted parameter, determining whether the preference exceeds a predetermined reference value, and generating a preferred program registration signal if it is determined that the preference exceeds the predetermined reference value; and in response to the preferred program registration signal, detecting an ID of the currently broadcast TV program from electronic program guide (EPG) information, and storing the detected ID in the preferred program list.

### BACKGROUND OF THE INVENTION

This application claims priority from Korean Patent Application No. 10-2004-0068289, filed on Aug. 28, 2004, in the Korean Intellectual Property Office, the disclosure of which is incorporated herein in its entirety by reference.

1. Field of the Invention

Methods and apparatuses consistent with the present invention relate to proactive recording and displaying of a preferred television (TV) program by a user's eye gaze, and more particularly, to proactive recording and displaying of a preferred TV program by a user's eye gaze, which prevents the user from missing preferred programs without requiring manual searching and recording by the user.

2. Description of the Related Art

With the spread of digital media, the integration of communication, computer, and broadcast technology has been accelerated. For example, unlike analog TVs, digital TVs are compatible with other digital media devices such as computers, digital versatile disk (DVD) players, and digital camcorders. Additionally, digital TV receivers can provide other information, in addition to voice and images, through data broadcasting.

According to the data broadcasting, information may be multiplexed and transmitted during vertical blanking intervals of TV video signals, or multimedia information including text information, still images, product information, and program schedules are provided to users having digital TV receivers or computers through a special channel. Accordingly, broadcast companies using the data broadcasting can provide users with additional information, such as program guide information, telemarketing information including product information, and prompt information such as breaking news, sports game information, real-time stock information, weather information, and traffic information.

An electronic program guide (EPG) is a kind of program guide information and avoids the difficulty in posting program guide information for numerous broadcast channels in a newspaper or a magazine. The EPG allows guide information such as broadcast channels, program titles, and broadcast time to be displayed on a screen of a TV receiver. The EPG also provides a service-on-demand so that if a user inputs a favorite genre such as movies or sports, a viewing time, and a channel, the user can be provided with guides to TV programs related to the input information for a period of several days.

Conventionally, if a user wants to view a program broadcast while the user is away, the user needs to check the program schedule in a newspaper and schedule a recording by inputting the broadcast time or a G-code of the program using a remote control. However, with the EPG, the user need only select his/her program of preference from a program schedule displayed on a TV screen and press a schedule recording button, so that an automatic recording function operates at a time when the program is broadcast. When using the EPG in such a manner, however, the user is still bothered by having to search a large amount of EPG information and manually select a program of preference.

For example, if a user does not schedule a recording of a program using the EPG because of an expectation of arriving home early enough to watch the program, but cannot make it home in time since a meeting extends beyond a scheduled end time, the user will miss the program. In this case, the user does not have any chance to view the program if the program is not rebroadcast, or can only restrictively see it on a broadcast company's home page with a low picture quality.

Moreover, even though users do not want to miss a preferred program, they feel annoyed with the amount of effort (i.e., scheduling a recording) required to prevent missing the preferred program. For example, a G-code system that allows a user to schedule a recording by inputting a G-code corresponding to a preferred program, which is provided on a program schedule in a newspaper or a magazine, was introduced for conveniently scheduling recording of programs, but is rarely used.

### SUMMARY OF THE INVENTION

The present invention provides a method and apparatus for estimating preferences for programs based on a user's eye gaze information acquired in advance, storing IDs of programs determined as favored by the user based on the estimated preferences, automatically recording a program determined as favored using the ID of the program without a special command, and playing the recorded program when the user desires.

According to an aspect of the present invention, there is provided a method of setting a preferred program list based on EPG information of TV programs preferred by a user based on the user's eye gaze, the method comprising: extracting a parameter used to estimate the a preference of the user for a currently broadcast TV program from information on the user's eye gaze obtained through a camera; estimating the preference based on the extracted parameter, determining if the preference exceeds a predetermined reference value, and generating a preferred program registration signal if it is determined that the preference exceeds the predetermined reference value; and in response to the preferred program registration signal, detecting an ID of the currently broadcast TV program from the EPG information, and storing the detected ID in the preferred program list.

According to another aspect of the present invention, there is provided a method of recording a TV program estimated as being preferred by a user, the method comprising: determining if a currently broadcast TV program is a preferred TV program of the user; determining if the user is watching the currently broadcast TV program based on information on the user's eye gaze; and if it is determined that the currently broadcast TV program is the preferred TV program and the user is not watching the currently broadcast TV program, recording the currently broadcast TV program.

According to still another aspect of the present invention, there is provided an apparatus for setting a preferred program list based on a user's eye gaze, the apparatus comprising: a camera unit which acquires information on the user's eye gaze while the user is watching a currently broadcast TV program; a parameter extractor which extracts a parameter used to estimate a preference of the user for the currently broadcast TV program from the information on the user's eye gaze; a preference estimator which estimates the preference based on the parameter, determines if the preference exceeds a predetermined reference value, and outputs a preferred program registration signal if the value of the preference exceeds the predetermined reference value; a storage unit which stores the preferred program list; and a control unit which controls storing of an ID of the currently broadcast TV program into the preferred program list in the storage unit, in response to the preferred program registration signal.

According to yet another aspect of the present invention, there is provided an apparatus for recording a TV program classified as a preferred TV program in a preferred program list, the apparatus comprising: a storage unit which stores the preferred program list and the preferred TV program; a camera unit which acquires information on an eye gaze of a user watching a currently broadcast TV program; a parameter extractor which extracts a parameter used to determine if the user is watching the currently broadcast TV program from the information on the eye gaze of the user; and a control unit which compares a first ID of the currently broadcast TV program and a second ID of the preferred TV program stored in the preferred program list based on EPG information and performs control to record and store the currently broadcast TV program in the storage unit if the first ID and the second ID are the same.

According to a further aspect of the present invention, there is provided a computer readable recording medium for storing a program executing one of the above-described methods.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for proactive recording of a preferred TV program based on a user's eye gaze, according to an exemplary embodiment of the present invention;

FIG. 2 illustrates an example of a TV program's ID used in the apparatus shown in FIG. 1;

FIG. 3 is a flowchart of a method of storing an ID of a TV program preferred by a user, according to an exemplary embodiment of the present invention;

FIG. 4 illustrates a method of determining a user's preference based on the user's eye gaze, as used in the method shown in FIG. 3;

FIGS. 5A and 5B illustrate a procedure of acquiring information on the user's eye gaze, as used in the method shown in FIG. 3;

FIG. 6 is a flowchart of a method for proactive recording of a preferred TV program based on a user's eye gaze, according to an exemplary embodiment of the present invention; and

FIG. 7 is a flowchart of a method for watching a previously recorded TV program, according to an exemplary embodiment of the present invention.

### DETAILED DESCRIPTION OF THE EXEMPLARY EMBODIMENTS OF THE PRESENT INVENTION

The present invention will now be described more fully with reference to the accompanying drawings, in which exemplary embodiments of the invention are shown.

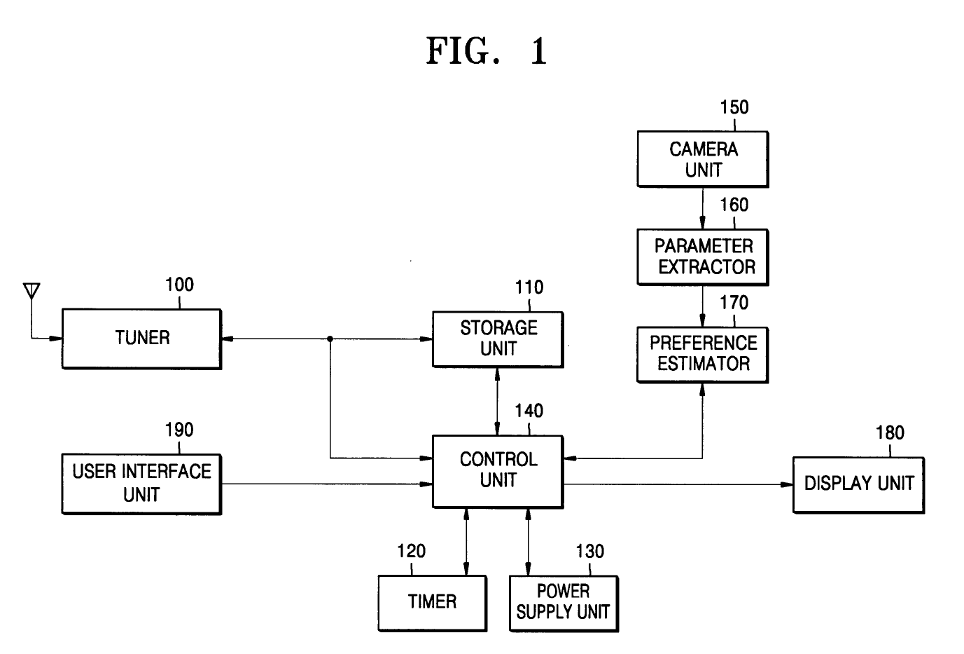

FIG. 1 is a block diagram of an apparatus for proactive recording of a preferred TV program based on a user's eye gaze, according to an exemplary embodiment of the present invention. Referring to FIG. 1, the apparatus includes a tuner 100, a storage unit 110, a timer 120, a power supply unit 130, a control unit 140, a camera unit 150, a parameter extractor 160, a preference estimator 170, a display unit 180, and a user interface unit 190.

The tuner 100 is controlled by the control unit 140 to tune a channel to receive a broadcast signal received through an antenna. The storage unit 110 stores EPG information, stores an ID of a preferred TV program in a preferred program list, and stores a TV program recorded while the TV program is broadcast. The timer 120 provides time information to the control unit 140. The power supply unit 130 supplies power to each element of the apparatus, senses power at which each element operates, and provides a power sensing signal to the respective element. The user interface unit 190 provides a user interface. The camera unit 150 acquires information on a user's eye gaze, while the user is watching a TV program currently being broadcast. The parameter extractor 160 receives the information on the user's eye gaze from the camera unit 150 and extracts a parameter for estimation of a preference of the user for the TV program currently being broadcast. The preference estimator 170 estimates the user's preference based on the parameter extracted by the parameter extractor 160, determines if the estimated preference of the user exceeds a predetermined reference value, and outputs a preferred program registration signal. The display unit 180 displays the TV program stored in the storage unit 110. The control unit 140 controls the storing of an ID of the currently broadcast TV program into the preferred program list based on the EPG information stored in the storage unit 110, in response to the preferred program registration signal received from the preference estimator 170.

If it is determined that the preferred program list stored in the storage unit 110 includes a TV program having the same ID as the currently broadcast TV program, the control unit 140 performs control to record the currently broadcast TV program. Additionally, the control unit 140 performs control to display a TV program stored in the storage unit 110 through the display unit 180 if predetermined conditions are satisfied, for example, if a user wants to view the TV program. The control unit 140 also performs control to delete a TV program from the storage unit 110 if other predetermined conditions are satisfied, for example, if the user declines view of the TV program.

The user interface unit 190 may be implemented, for example, by a keypad or an infrared (IR) receiver. The user interface unit 190 receives input from the user and outputs a corresponding signal to the control unit 140. Here, the IR receiver receives the input from an IR remote operated by the user. The IR remote may be, for example, a wireless mouse such as an air mouse or a remote controller. The control unit 140 controls each element of the apparatus to perform an operation corresponding to the input of the user received through the keypad or the IR receiver, based on a control program stored in the storage unit 110 in advance.

The timer 120 outputs the time information to the control unit 140 after the user sets a current time in the timer 120. In addition to its use in a method of recording a currently broadcast TV program, having an ID that is the same as an ID of a TV program stored in the preferred program list, based on the estimated preference of the user according to an exemplary embodiment of the present invention, the timer 120 allows the user to record a TV program in a conventional manner using the time information input through the timer 120. For example, the user can directly schedule a recording of a TV program by inputting a desired time for the recording, and a title of the TV program or corresponding EPG information. Here, the timer 120 outputs current time information to the control unit 140. Accordingly, the exemplary embodiments of the present invention may also provide a conventional recording function.

The storage unit 110 includes read-only memory (ROM) which stores the control program for the control unit 140, random access memory (RAM) which temporarily stores data generated when the control unit 140 executes the control program, electrically erasable and programmable ROM (EEPROM) or flash memory which stores reference data such as various messages, and a hard disk drive which stores a recorded TV program. Furthermore, the reference data may be stored in the hard disk drive. The various messages (e.g., “Do you want to view Z recorded from X p.m. to Y p.m. on Friday? If you want to, press 1. If you don't, press 0.”) are provided to a user to determine if the user wants to view the recorded TV program, and may be stored in the EEPROM or the flash memory in advance. Here, X, Y, and Z are variables varying with an ID of the recorded TV program.

Operating power supplied to each element of the apparatus is controlled by the control unit 140. The operating power is supplied in one of two different modes: normal mode and standby mode. In normal mode, the operating power is supplied to all parts of the apparatus. In standby mode, the operating power is not supplied to all parts of the apparatus, for example, operating power is not supplied to the units 150, 160, and 180. In standby mode, because the display unit 180 is not receiving operating power, a user may regard the apparatus as being turned off, although the apparatus continues to receive TV signals, compare IDs for estimating the user's preference, and record a TV program classified as being a preferred TV program of the user. The user can change the mode by turning a “main power switch” on and off. If the main power switch is turned off, the apparatus enters the standby mode and the display unit 180, the camera unit 150 and the parameter extractor 160 are powered off, while the other units in the apparatus continue to be powered. If the main power switch is turned on, the apparatus enters the normal mode and all units in the apparatus are powered. Accordingly, the user is able to watch TV programs in the normal mode but not in the standby mode.

An ID of a TV program includes, for example, a title of the TV program, a unique number associated with the TV program, a property that the TV program shares with other TV programs, such as a category (e.g., news, sports, or drama) of the TV program, etc.

More detailed operations of the elements of the apparatus are set forth below.

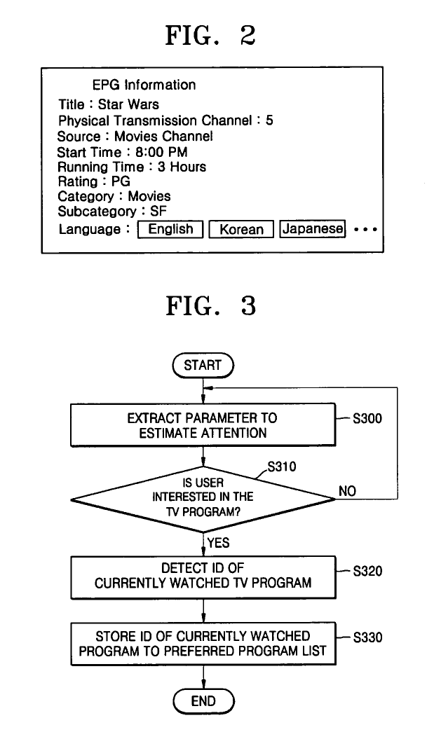

FIG. 2 illustrates an example of a TV program's ID used in the apparatus shown in FIG. 1. Referring to FIG. 2, the TV program's ID may include a title, a physical transmission channel, a source, a start time, a running time, a rating, a category, a subcategory, and language information. The TV program's ID may be all of the EPG information input through the tuner 100 or may be acquired by extracting part of the EPG information. Various modifications may be made to the TV program's ID, as the ID shown in FIG. 2 is merely an example.

FIG. 3 is a flowchart of a method of storing an ID of a TV program preferred by a user, according to an exemplary embodiment of the present invention. Referring to FIG. 3, in operation S300, the parameter extractor 160 shown in FIG. 1 extracts a parameter used to estimate a user's attention to a currently broadcast TV program from information on the user's eye gaze, which is acquired by the camera unit 150. For example, one or more of a fixation duration, an amount of fixation, a saccadic amplitude, and a blink rate may be extracted as the parameters. These parameters are useful in estimating the user's preference based on a human psychological and physiological phenomenon that people instinctively fix their eyes on an object of preference or an attractive object.

The fixation duration is a duration in which the user's eyes are fixed on the TV, within a predetermined range.

The amount of fixation is an intensity with which the user's eyes are fixed on the TV, within the predetermined range. The amount of fixation may be expressed as a ratio of a period of time in which the user's eyes are fixed at a portion on the TV to a predetermined period of time.

The saccadic amplitude is an amplitude of the shaking of the user's eyeball and may be calculated using a degree of a saccadic shift of the user's focus on the TV based on the information on the user's eye gaze. The saccadic amplitude is useful as a parameter in estimating the user's preference based on the experimental fact that there is a correlation between a preference for an object gazed at by the user and suppression of the saccade of the user's eyeball.

The blink rate may be calculated by analyzing a rate of interruption of a predetermined data signal in the information on the user's eye gaze. The blink rate is useful as a parameter in estimating the user's preference based on the experimental fact that a rate of blinking is generally low when people concentrate.

Here, at least one parameter may be used to estimate the user's preference. Estimation reliability increases in proportion to the number of parameters used.

Next, in operation S310, the preference estimator 170 estimates if a currently watched TV program is interesting to a user. In other words, the preference estimator 170 estimates the user's preference for the current TV program based on the extracted parameter and determines if the preference exceeds a predetermined reference value. Here, the preference is estimated using parameters such as those described above. For example, an amount of fixation and a blink rate may be used to estimate the user's preference.

As described above, the amount of fixation may be expressed as a ratio of a period of time that the user's eyes are fixed on the TV, within the predetermined range, to a predetermined period of time. For example, if a total period of time that the user's eyes are fixed on the TV is five minutes during a survey time of 10 minutes, the amount of fixation is 50%. From this value, it may be determined if the user's preference exceeds the predetermined reference value. This is just an example and is not intended to limit the present invention in any way.

In an example of using the blink rate as a parameter, if the user blinks less than seven to eight times in one minute, it may be determined that the preference exceeds the predetermined reference value. This is just an example and is not intended to limit the present invention in any way.

Furthermore, a plurality of parameters may be considered together to estimate the user's preference for the TV program. Additionally, correlation between parameters and preferences obtained through various experiments may be stored in the preference estimator 170 or the storage unit 110 in a table form.

If it is determined, in operation S310, that the preference does not exceed the predetermined reference value, the method returns to operation S300.

However, if it is determined, in operation S310, that the preference exceeds the predetermined reference value, the preference estimator 170 outputs a preferred program registration signal to the control unit 140 to store an ID of the currently watched TV program, and the control unit 140 searches the storage unit 110 to detect an ID identifying the currently watched TV program in response to the preferred program registration signal, in operation S320. Here, the ID of the currently watched TV program can be detected in the EPG information stored in the storage unit 110.

In operation S330, the control unit 140 performs control to store the ID of the currently watched TV program in a preferred program list stored in the storage unit 110. The preferred program list contains IDs of a plurality of TV programs preferred by the user.

Furthermore, the user can delete an ID of a TV program from the preferred program list by operating the user interface unit 190. Additionally, without using the method shown in FIG. 3, the user can directly store an ID of a TV program in the preferred program list by operating the user interface unit 190.

As described above, in exemplary embodiments of the present invention, an ID of a TV program that a user is watching with preference is stored in the preferred program list of the storage unit 110 as basic information for recording the TV program in the future.

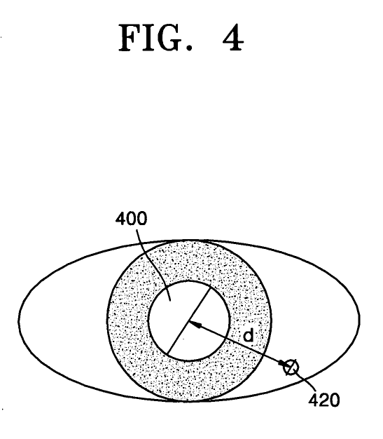

FIG. 4 illustrates a method of determining a user's preference based information on the user's eye gaze, as used in the method shown in FIG. 3. Referring to FIG. 4, the method of determining the user's preference is related with a method of estimating a position (hereinafter, referred to as a “gaze point”) at which the user gazes on a display screen, for example, the display unit 180 of the apparatus shown in FIG. 1. In detail, the camera unit 150 estimates a point at which the user, within a viewing angle of a charge-coupled device (CCD) or a complementary metal-oxide semiconductor (CMOS) camera, gazes on the display screen using a near infrared light emitting diode (LED).

FIG. 4 illustrates a principle, used in various conventional techniques of estimating a gaze point, in which a gaze direction of an eye is estimated using a distance “d” between a bright point 420 appearing on a cornea of the eye due to reflection of an infrared ray and a pupil 400 of the eye. In association with this principle, a method of using a phenomenon that the pupil of the eye is brighter when an infrared LED is positioned on an optical axis of a camera to reliably detect a position of the pupil in an environment with high optical noise was introduced by T. E. Hutchinson [“Human-Computer Interaction Using Cybernetics”, IEEE Transaction on System, Man and Cybernetics, Vol. 19, No. 6, pp. 1527-1533, 1989]. Similarly, Korean Patent Publication No. 2003-0069531, entitled “Eye Gaze Point Estimation Method” discloses a technique of estimating a point on a screen corresponding to a center of a pupil on the assumption that four bright points appearing when infrared rays respectively emitted from four infrared LEDs respectively attached to four corners of a monitor are reflected from a cornea of an eye and are projected onto the screen of the monitor.

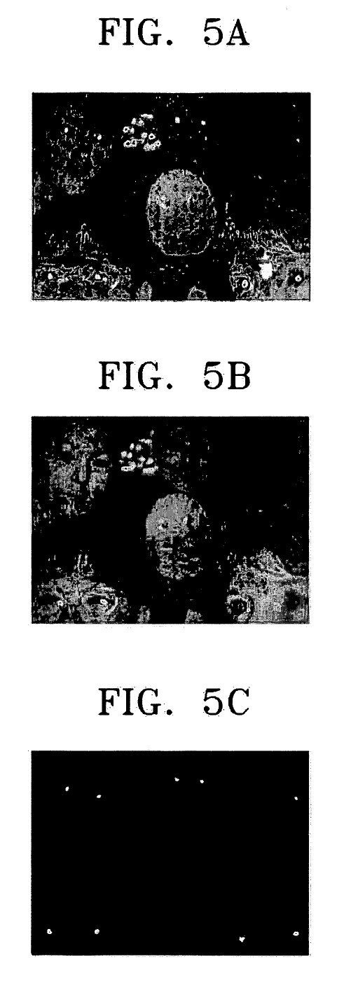

FIGS. 5A and 5B are photographs illustrating results of detecting positions of pupils of viewers within a viewing angle of a camera, which are disclosed in IBM's experiment paper entitled “What's in the Eyes for Attentive Input” as published in Communication of ACM on April 2003.

It has been an accepted theory in the field of psychology of perception that there is a strong causal relation or correlation between human attention and eye movements. This theory is described in detail in Chapter 3 (“Visual Attention and Eye Movements”) in an authorized text book, entitled “Attention”, written by Harold Pashler and published by Psychology Press.

The parameter extractor 160 shown in FIG. 1 extracts parameters used to estimate a user's preference for a currently broadcast TV program from information on the user's eye gaze obtained through the above-described methods.

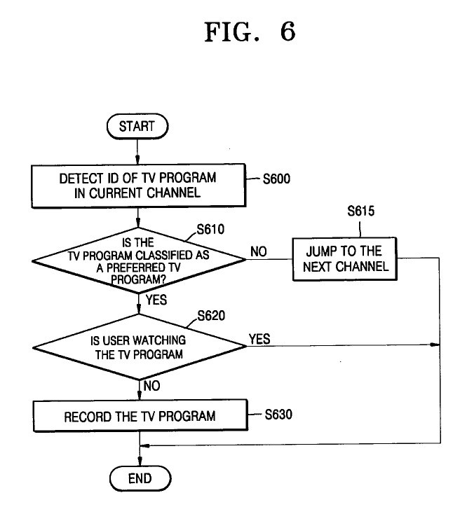

FIG. 6 is a flowchart of a method for proactive recording of a TV program determined to be preferred by a user based on the user's eye gaze, according to an exemplary embodiment of the present invention. Referring to FIG. 6, the proactive recording method records a TV program if a preferred TV program of the user is broadcast even though it isn't the TV program currently being watched by the user. First, in operation S600, an ID of a TV program in a currently tuned channel is detected. A recording method according to an exemplary embodiment of the present invention is usually performed when the system in FIG. 1 is in an “off” state. Here, the “off” state indicates that the display unit 180 in FIG. 1 is inactive while the other units in FIG. 1 are active. Therefore, in the “off” state, users regard the system, e.g., a TV set, as being “turned off” although all the functions, except for displaying images, are working. If the system is turned “on” by a user, the display unit 180 is activated and thereafter all the units in FIG. 1 are active.

The control unit 140 detects the ID of the TV program in the current channel, for example, using EPG information stored in the storage unit 110.

Next, in operation S610, it is determined if the ID of the TV program in the current channel is present in a preferred program list, which is stored in the storage unit 110 in advance and contains IDs of the user's preferred TV programs, as described above with reference to FIG. 3. If it is determined that the user does not prefer the TV program in the current channel, that is, when the ID of the TV program in the current channel is not present in the preferred program list, the method goes to the operation S615.

In operation S615, a TV program in the next channel is displayed. The operation S615 represents that the method of FIG. 6 applies to all of the channels.

However, if it is determined that the user prefers the TV program in the current channel, that is, when the ID of the TV program in the current channel is present in the preferred program list, in operation S620, it is determined if the user is watching the TV program in the current channel, i.e., a preferred TV program. Whether the user is watching the preferred TV program may be determined by whether the user's eye gaze is sensed by the camera unit 150 and whether a channel that the user is currently watching is the same as a channel of the preferred TV program. For example, if the user's eye gaze is not sensed or if channel information of a TV program that the user is currently watching is different from channel information of the preferred TV program stored in the preferred program list, even if the user's eye gaze is sensed, it is determined that the user is not watching the preferred TV program. If users are interested in two or more channels and one of the channels is being watched, operation S620 is applied only in the case that that TV has two or more TV tuners.

Additionally, it may be determined if power of a recording apparatus sensed through the power supply unit 130 is “on” or “off”. If it is determined that the power is off, it may be determined that the user is not watching the preferred TV program.

If it is determined that the user is watching the preferred TV program in operation S620, the method ends. Here, as described above, a power sensing signal indicating ON (hereinafter, referred to as a power ON sensing signal) is received from the power supply unit 130, the user's eye gaze is sensed by the camera unit 150, and the channel information of the TV program that the user is currently watching is the same as that of the preferred TV program stored in the preferred program list.

However, if it is determined that the user is not watching the preferred TV program, in operation S630, the TV program in the current channel is recorded in the storage unit 110. Here, it is preferable, but not necessary, that the storage unit 110 includes a hard disk drive for storing compressed TV programs. Since a large amount of data can be stored in the hard disk drive, many TV programs can be recorded and programs stored in the hard disk drive can be easily deleted by an operating signal input through the user interface unit 190. Additionally, the hard disk drive provides large capacity and is less expensive than other auxiliary memory devices.

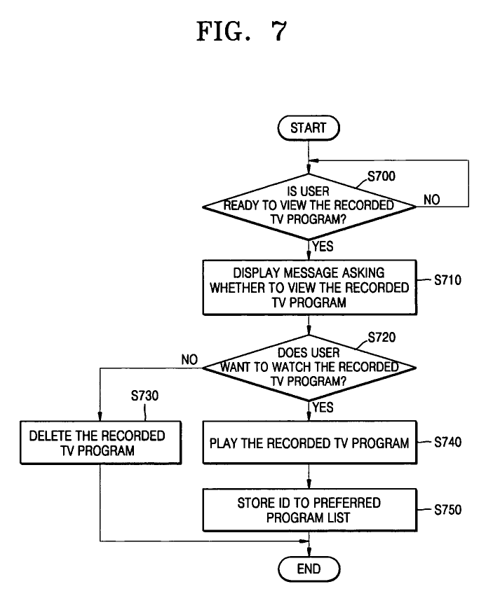

FIG. 7 is a flowchart of a method for watching a recorded TV program, according to an exemplary embodiment of the present invention. Referring to FIG. 7, in operation S700, it is determined if the user is ready to view the recorded preferred TV program, based on whether the power ON sensing signal is received from the power supply unit 130 and whether the user's eye gaze is sensed by the camera unit 150. Alternatively, it may be determined that the user is ready to view the recorded preferred TV program if the power ON sensing signal is received from the power supply unit 130.

If it is determined that the user is not ready to view the recorded preferred TV program, operation S700 is repeated. Here, the determination is performed every predetermined period (e.g., 3 seconds).

If it is determined that the user is ready to view the recorded preferred TV program, in operation S710, a message for confirming if the user wants to view the recorded preferred TV program is displayed through the display unit 180. For example, a message “Do you want to view KBS news recorded from 9:00 p.m. to 9:50 p.m. on Friday? If you want to, press 1. If you don't, press 0.” may be displayed. Such a message may be stored in the storage unit 110 in advance.

Next, in operation S720, the recording apparatus receives a signal indicating whether to view the recorded preferred TV program through the user interface unit 190. In other words, it is determined if the user wants to view the recorded preferred TV program according to a signal input by the user operating the user interface unit 190.

If it is determined that the user does not want to view the recorded preferred TV program (e.g., when the user presses “0” in operation S710), in operation S730, the recorded preferred TV program is deleted from the storage unit 110. Here, a message for confirming if the user wants to set the recording apparatus so as not to record the TV program afterward may be displayed through the display unit 180. For example, a message “Is it OK if the recently deleted KBS news is not recorded continuously afterward? If it's OK, press 1. If you want to continue recording of the KBS in the future, press 0.” may be displayed. Such a message may be stored in the storage unit 110 in advance.

The recording apparatus may be set not to record a TV program having the same ID as the recorded preferred TV program (e.g., to input “1” in the above example) or to keep recording the TV program having the same ID as the recorded preferred TV program (e.g., to input “0” in the above example) by the user operating the user interface unit 190.

If it is determined that the user wants to view the recorded preferred TV program (e.g., if the user presses “1” in operation S710), in operation S740, the recorded preferred TV program is played and displayed through the display unit 180. Then, the user can view the recorded preferred TV program through the display unit 180. After the user views the recorded preferred TV program, the control unit 140 may display a message for confirming if the user wants to delete or keep the recorded preferred TV program through the display unit 180. For example, a message “Do you want to delete the KBS news that was recorded from 9:00 p.m. to 9:50 p.m. on Friday and that you just viewed? If you want to delete it, press 1. If you want to keep it, press 0.” may be displayed. Such a message may be stored in the storage unit 110 in advance. The recorded TV program may be deleted (e.g., if “1” is input) or may be kept (e.g., if “0” is input) by the user operating the user interface unit 190.

Next, in operation S750, the ID of the watched TV program is stored in the preferred program list.

Only exemplary embodiments of the present invention have been described. However, since a function of recording and displaying a TV program determined to be a preferred TV program based on a user's eye gaze, according to the exemplary embodiments of the present invention, can be implemented together with a conventional function of scheduling a recording of a TV program based on EPG information, the present invention can be applied to such a conventional recording system and provide further convenience for users.

The exemplary embodiments of the present invention, as described above, may provide the following effects. Firstly, since a user's preference for a TV program is determined using the user's attention/preference quantitatively estimated based on the user's eye gaze, such that the TV program or a similar TV program is recorded using EPG information, it is quite probable that the user does not miss the TV program that the user likes without being bothered by recognizing and scheduling a recording of the TV program.

Secondly, the exemplary embodiments of the present invention do not displace a conventional recording system based on EPG, but instead add a proactive recording function to the conventional recording system. Accordingly, a user can record a TV program that the user never wants to miss by using a conventional schedule recording function based on EPG, and a TV program of which the user did not recognize the broadcasting information or for which the user did not set a scheduled recording can be recorded. As a result, the exemplary embodiments of the present invention are a complement to the conventional technology. Even if an undesired TV program is recorded, it can be easily deleted. So, since a cost for inaccurately determining a TV program to be a preferred TV program is very low, the present invention does not irritate the user compared to the conventional recording system.

Thirdly, without being bothered by having to directly input TV programs that he or she has an inclination toward, the user can be provided with the TV programs preferred by him or her from among a great number of TV programs (e.g., provided through several tens or hundreds of channels) just by watching TV.

Exemplary embodiments of the present invention can also be embodied as computer readable codes on a computer readable recording medium. The computer readable recording medium is any data storage device that can store data which can be thereafter read by a computer system. Examples of the computer readable recording medium include ROM, RAM, CD-ROMs, magnetic tapes, floppy disks, optical data storage devices, and carrier waves (such as data transmissions through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of setting a preferred program list based on electronic program guide (EPG) information of television (TV) programs preferred by a user, the method comprising:
extracting a parameter used to estimate a preference of the user for a currently broadcast TV program from information on the user's eye gaze obtained through a camera;
estimating the preference based on the parameter, determining whether the preference exceeds a predetermined reference value, and generating a preferred program registration signal if the preference exceeds the predetermined reference value; and
in response to the preferred program registration signal, detecting an ID of the currently broadcast TV program from the EPG information, and storing the ID in the preferred program list.

2. The method of claim 1, wherein the parameter is a fixation duration obtained from the information on the user's eye gaze.

3. The method of claim 1, wherein the parameter is one of a fixation duration, an amount of fixation, a saccadic amplitude, and a blink rate, obtained from the information on the user's eye gaze.

4. The method of claim 1, wherein the parameter is a plurality of a fixation duration, an amount of fixation, a saccadic amplitude, and a blink rate, obtained from the information on the user's eye gaze.

5. The method of claim 1, wherein the ID is predetermined information in the electronic program guide (EPG) information.

6. The method of claim 5, wherein the predetermined information comprises a broadcast channel, a broadcast time, and a title, of the current broadcast television (TV) program.

7. A method of recording a television (TV) program estimated as being preferred based on a user's eye gaze, the method comprising:
detecting an ID of a currently broadcast TV program;
determining whether the currently broadcast TV program is a preferred TV program of the user;
determining whether the user is watching the currently broadcast TV program based on information on the user's eye gaze; and
if it is determined that the currently broadcast TV program is the preferred TV program of the user and if it is determined that the user is not watching the currently broadcast TV program, recording the currently broadcast TV program.

8. The method of claim 7, wherein the determining whether the user is watching the currently broadcast television (TV) program comprises determining whether the user's eye gaze is directed toward a TV screen displaying the currently broadcast TV program.

9. The method of claim 7, wherein the determining whether the user is watching the currently broadcast television (TV) program comprises:
determining whether channel information of the currently broadcast TV program is the same as channel information of a TV program that the user is currently watching; and
determining whether the user's eye gaze is directed toward a TV screen displaying the currently broadcast TV program.

10. The method of claim 7, wherein the ID is predetermined information in electronic program guide (EPG) information.

11. The method of claim 10, wherein the predetermined information comprises a broadcast channel, a broadcast time, and a title, of the currently broadcast television (TV) program.

12. The method of claim 7, wherein recording the currently broadcast television (TV) program comprises storing the currently broadcast TV program in a hard disk drive.

13. The method of claim 7, wherein the determining whether the currently broadcast television (TV) program is the preferred TV program of the user comprises comparing the ID of the currently broadcast TV program to an ID of each TV program stored in the preferred program list.

14. The method of claim 11, wherein the predetermined information further comprises a category of the currently broadcast television (TV) program.

15. The method of claim 7, further comprising:
displaying a message showing the ID of a recorded television (TV) program and asking whether the user wants to view the recorded TV program;
determining whether the user wants to view the recorded TV program according to a response signal responding to the message; and
playing the recorded TV program if it is determined that the user wants to view the recorded TV program.

16. The method of claim 15, further comprising deleting the recorded television (TV) program if it is determined that the user does not want to view the recorded TV program.

17. The method of claim 16, further comprising, before displaying the message, determining whether the user is ready to view the recorded television (TV) program by determining whether a main power switch is turned on.

18. The method of claim 16, further comprising, before displaying the message, determining whether the user is ready to view the recorded television (TV) program by measuring whether the user's eye gaze is detected.

19. The method of claim 15, wherein the response signal is generated from the user by operating a user interface unit.

20. An apparatus for setting a preferred program list based on a user's eye gaze, the apparatus comprising:
a camera unit which acquires information on the user's eye gaze, while the user watches a currently broadcast television (TV) program;
a parameter extractor which extracts a parameter used to estimate a preference of the user for the currently broadcast TV program from the information on the user's eye gaze;
a preference estimator which estimates the preference based on the parameter, determines whether the preference exceeds a predetermined reference value, and outputs a preferred program registration signal if the preference exceeds the predetermined reference value;
a storage unit which stores the preferred program list; and
a control unit performs control to store an ID of the currently broadcast TV program into the preferred program list in the storage unit, in response to the preferred program registration signal.

21. The apparatus of claim 20, wherein the camera unit comprises a near infrared light emitting diode (LED), and a charge-coupled device (CCD) camera or a complementary metal-oxide semiconductor (CMOS) camera.

22. The apparatus of claim 20, wherein the parameter is a fixation duration obtained from the information on the user's eye gaze.

23. The apparatus of claim 20, wherein the parameter is one of a fixation duration, an amount of fixation, a saccadic amplitude, and a blink rate, obtained from the information on the user's eye gaze.

24. The apparatus of claim 20, wherein the parameter is a plurality of a fixation duration, an amount of fixation, a saccadic amplitude, and a blink rate, obtained from the information on the user's eye gaze.

25. An apparatus for recording a television (TV) program classified in a preferred program list as a preferred TV program of a user, the apparatus comprising:
a storage unit which stores the preferred program list and the preferred TV program;
a camera unit which acquires information on the user's eye gaze, while the user watches a currently broadcast TV program;
a parameter which extracts a parameter used to determine whether the user is watching the currently broadcast TV program from the information on the user's eye gaze; and
a control unit which compares a first ID of the currently broadcast TV program with a second ID of the preferred TV program stored in the preferred program list based on electronic program guide (EPG) information and performs control to store the currently broadcast TV program in the storage unit if the first ID and the second ID are the same.

26. The apparatus of claim 25, wherein the storage unit comprises a hard disk drive.

27. The apparatus of claim 25, further comprising a display unit which displays a recorded TV program stored in the storage unit,
wherein the control unit performs control to display the recorded TV program if it is determined that the user is ready to view the recorded TV program.

28. The apparatus of claim 27, wherein the control unit performs control to display a message through the display unit for confirming whether the user wants to view the recorded TV program through the display unit, before performing control to display the recorded TV program through the display unit.

29. The apparatus of claim 28, further comprising a user interface unit which senses a response signal input by the user in response to the message and provides the response signal to the control unit,
wherein the control unit receives the response signal from the user interface unit and controls output of the recorded TV program to the display unit if the response signal indicates to display the recorded TV program.

30. The apparatus of claim 27, wherein it is determined that the user is ready to view the recorded TV program if the user's eye gaze is detected.

31. The apparatus of claim 27, further comprising a power supply unit which senses a power of the apparatus and outputs a power sensing signal to the control unit,
wherein it is determined that the user is ready to view the recorded TV program if the power supply unit outputs the power sensing signal indicating that a main power is sensed.

32. A computer readable recording medium storing a program for performing a method of setting a preferred program list based on electronic program guide (EPG) information of television (TV) programs preferred by a user, the method comprising:
extracting a parameter used to estimate a preference of the user for a currently broadcast TV program from information on the user's eye gaze obtained through a camera;
estimating the preference based on the parameter, determining whether the preference exceeds a predetermined reference value, and generating a preferred program registration signal if the preference exceeds the predetermined reference value; and
in response to the preferred program registration signal, detecting an ID of the currently broadcast TV program from the EPG information, and
storing the ID in the preferred program list.

33. A computer readable recording medium storing a program for performing a method of recording a television (TV) program estimated as being preferred based on a user's eye gaze, the method comprising:
detecting an ID of a currently broadcast TV program;
determining whether the currently broadcast TV program is a preferred TV program of the user;
determining whether the user is watching the currently broadcast TV program based on information on the user's eye gaze; and
if it is determined that the currently broadcast TV program is the preferred TV program of the user and if it is determined that the user is not watching the currently broadcast TV program, recording the currently broadcast TV program.
